(19) United States
(12) Patent Application Publication
(10) Pub. No.: US 2017/0176261 A1
(43) Pub. Date: Jun. 22, 2017

(54) SENSING ELEMENT AND SENSING PROCESS

(71) Applicants: Alexander Raymond KING, Lancaster, PA (US); Quentin Francis POLOSKY, Santa Clara, CA (US); Mohammad Siddique AHMED, Mechanicsburg, PA (US); Richard Bruce LLOYD, Sunnyvale, CA (US); Robert Joseph BARAGONA, Hershey, PA (US); Ganesh Shivaram BHATT, Dallastown, PA (US)

(72) Inventors: Alexander Raymond KING, Lancaster, PA (US); Quentin Francis POLOSKY, Santa Clara, CA (US); Mohammad Siddique AHMED, Mechanicsburg, PA (US); Richard Bruce LLOYD, Sunnyvale, CA (US); Robert Joseph BARAGONA, Hershey, PA (US); Ganesh Shivaram BHATT, Dallastown, PA (US)

(21) Appl. No.: 14/973,183

(22) Filed: Dec. 17, 2015

(51) Int. Cl. G01K 7/22

(52) U.S. Cl. CPC G01K 7/22

(57) ABSTRACT

Sensing elements and sensing processes are disclosed. The sensing element includes a conductive composite. The conductive composite has an observable property corresponding to an external condition. The sensing element is positioned for changes in the external conditions to be identifiable in a system in response to monitoring of the observable property of the conductive composite by at least a portion of the system. The sensing process includes providing the sensing element having the conductive composite, and monitoring the observable property of the conductive composite corresponding to the external condition. This observable property may be monitored either while the change in external condition is taking place or measured later in the case of a composite material with memory. The sensing element is positioned for changes in the external condition to be identifiable in a system in response to the monitoring of the observable property of the conductive composite by at least a portion of the system.

### FIELD OF THE INVENTION

The present invention is directed to sensing elements and sensing processes. More particularly, the present invention is directed to sensing elements and sensing processes relying upon a conductive composite, this composite being specified either through material composition, geometry, or other definable characteristic of the device, to have suitability for sensor applications.

### BACKGROUND OF THE INVENTION

Current environmental sensor technology can include sensing elements that operate as discrete components within an electrical sub-system, such components being of pre-defined mechanical dimensions and requiring additional integration effort. Such architecture can often produce challenges related to the form and fit of a product requiring environmental sensing elements.

Sensor technology can be relatively complex, which leads to expensive manufacturing and higher risk of failure. Such failure can be especially problematic when replacement of such sensors requires down-time of large systems that are expansive to shut down.

The cost of sensors in the current state of the art can be high. This high consumer cost can be driven by raw material cost, manufacturing complexity, manufacturing process cost, or other factors relating to the design and production of sensors.

Sensors manufactured with a certain process are often not suited for harsh environments. Sensors may be susceptible to heat, cold, humidity, radiation, corrosive gasses, pressure, or other environmental conditions not listed here. Use in these environments can reduce the functional life of the sensor, reduce accuracy, reduce responsiveness, or some combination of these.

A sensor and sensing process that show one or more improvements in comparison to the prior art would be desirable in the art.

### BRIEF DESCRIPTION OF THE INVENTION

In an embodiment, a sensor includes a conductive composite element. The conductive composite has an observable property corresponding to an external condition. The sensor is positioned for changes in the external conditions to be identifiable in a system in response to monitoring of the observable property of the conductive composite by at least a portion of the system.

In another embodiment, a sensing element includes a conductive composite. The conductive composite has an observable property corresponding to external conditions. The sensing element is positioned for changes in the external conditions to be identifiable in a system in response to monitoring of the observable property of the conductive composite by at least a portion of the system. The observable property is selected from the group consisting of or containing resistance, color, volume, shape, temperature, and thermal expansion. The external condition is selected from the group consisting of temperature, pressure, voltage, and current. The conductive composite is injection molded, machined, laser cut, potted, or additively produced. The sensing element is integrated into an electronic component selected from the group consisting of or containing a molded interconnect device, a thermistor, an electrical connector, a circuit protection device, a housing, or any other device suitable for the integration of a sensing element having the functionality described herein, and combinations thereof.

In another embodiment, a sensing process includes providing a sensing element having a conductive composite element, and monitoring an observable property of the conductive composite corresponding to an external condition. The sensing element is positioned for changes in the external condition to be identifiable in a system in response to the monitoring of the observable property of the conductive composite by at least a portion of the system.

In another embodiment, a sensing element includes a conductive composite element, this composite having some observable property which responds to external conditions in an observable or measureable way. This sensing element can respond to any changes in temperature, humidity, pressure, presence of electrical current, mechanical force, or any combination of these or other measurable environmental or operating conditions according to the magnitude of the change in conditions. The changes in the observable property of the composite shall be persistent and/or permanent even after the environmental or operational condition is removed. The quantifiable value of this observable property can be compared to a baseline value, the difference corresponding to some historical environmental or operational condition.

In the above embodiment, any change in the sensing elements characteristic property corresponds to a historical condition encountered by the sensing element. This gives the sensing element memory to report on past peak magnitude events.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a perspective view of an embodiment of a sensing element capable of performing an embodiment of a sensing process, according to the disclosure.

Wherever possible, the same reference numbers will be used throughout the drawings to represent the same parts.

### DETAILED DESCRIPTION OF THE INVENTION

Provided are sensing elements and sensing processes. Embodiments of the present disclosure, for example, in comparison to concepts failing to include one or more of the features disclosed herein, ameliorate challenges related to the form and fit of products, increase simplicity of products, extend the useful life of products, decrease risk of product failure, save manufacturing and final product cost, broaden the useable product environments (harsher environments), increase integration ease into new and existing circuitry framework, allow for more automated or higher volume manufacturing processes, reduce size or footprint of circuitry framework, provide functionality not achievable without complex circuitry, or combinations thereof.

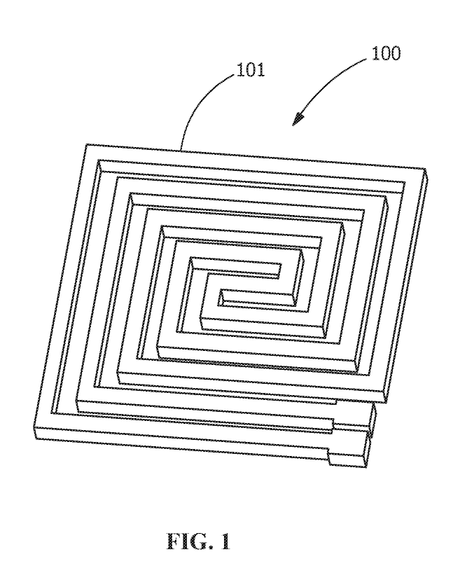

Referring to FIG. 1, in one embodiment, an illustrative sensing element 100 is made from a conductive composite 101. The sensing element 100 shown is a representative element, as the element can be formed or manufactured in many different configurations. The conductive composite has an observable property corresponding to an external condition. The sensing element 100 is positioned for changes in the external conditions to be identifiable in a system (not shown) in response to monitoring of the observable property of the conductive composite 101 by at least a portion of the system. The system is capable of being a computerized system, a human, a camera, a digital system, a visual system, an audio system, another sensor(s), an internet-connected system, or combination or derivative thereof.

The observable property is any suitable property that is identifiable through qualitative and/or quantitative techniques. Suitable observable properties include, but are not limited to, resistance, conductivity, color (for example, in embodiments where the conductive composite 101 includes a temperature-sensitive dye), thermal expansion, position, temperature, dimension (size), surface finish (gloss or roughness), reflectivity, IR (infrared) absorption, volume, shape, any property related to the mechanical, material, or electrical performance of the composite, or a combination thereof. The observable properties are capable of increasing or decreasing in values.

The external condition is any suitable condition capable of impacting the conductive composite 101. Suitable external conditions include, but are not limited to, temperature, pressure, voltage, current, humidity, radiation (UV, IR, nuclear), exposure to signal (wifi, bluetooth, RF, etc.) or a combination thereof. The external conditions are capable of increasing or decreasing in values.

In one embodiment, the conductive composite 101 is physically constrained. Physically constraining the conductive composite 101 permits changes in the external condition to result in the observable property being irreversibly changed. Stated another way, upon the external condition changing (for example, temperature increasing) the observable property changes (for example, resistance increasing) independent of whether the external conditions revert to an original condition (for example, returning to the original lower temperature). Alternatively, in one embodiment, the conductive composite 101 is not physically constrained. In this embodiment, the observable property reversibly changes, for example, allowing reverting of the external condition to the original condition results in the observable property being changed to the original property.

In one embodiment, the conductive composite 101 is composed of a material having specified elasticity and material characteristics. These characteristics allow changes in an external condition to result in the observable property being irreversibly changed. Stated another way, upon the external condition changing (for example, temperature increasing) the observable property changes (for example, resistance increasing) independent of whether the external conditions revert to an original condition (for example, returning to the original lower temperature).

To produce the sensing element 100, the conductive composite 101 is processed by any suitable technique. Suitable techniques include, but are not limited to, injection molding, potting, extruding, additive techniques (for example, FDM (fused deposition modeling)), printing techniques or combinations thereof. The conductive composite 101 forms the substrate of the sensing element 100 or is applied to a substrate of the sensing element 100.

The sensing element 100 is stand-alone or integrated into another system or device. For example, in one embodiment, the sensing element 100 is integrated into an electronic component selected from the group consisting of a molded interconnect device, a thermistor (for example, a positive temperature coefficient thermistor), an electrical connector, a circuit protection device, an antenna, a housing, a transducer, an electronic or mechanical assembly including other devices not related to sensing, and combinations thereof.

The sensing element 100 is capable of being used in a sensing process. In one embodiment, the sensing process includes providing the sensing element 100, and monitoring the observable property of the conductive composite 101 corresponding to the external condition. In this embodiment, the sensing element 100 is positioned for changes in the external condition to be identifiable in a system (not shown) in response to the monitoring of the observable property of the conductive composite 101 by at least a portion of the system.

The conductive composite 101 includes a resin matrix and a conductive filler or fillers, with or without one or more additives to provide properties corresponding with the desired application. Although not intending to be bound by theory, according to one embodiment, such properties are based upon the composition of the conductive composite 101 having a binary combination of copper and tin. In further embodiments, other suitable features of the conductive composite 101 are based upon the materials described hereinafter.

The conductive filler is or includes copper particles, tin particles, nickel particles, aluminum particles, carbon particles, carbon black, carbon nanotubes, graphene, silver-coated particles, nickel-coated particles, silver particles, metal-coated particles, conductive alloys, alloy-coated particles, other suitable conductive particles compatible with the resin matrix, or a combination thereof. Suitable morphologies for the conductive particles include, but are not limited to, dendrites, flakes, fibers, and spheres. Suitable resin matrices include, but are not limited to, ethylene-vinyl acetate (EVA), acrylics, polyvinyl acetate, ethylene acrylate copolymer, polyamide, polyethylene, polypropylene, polyester, polyurethane, styrene block copolymer, polycarbonate, fluorinated ethylene propylene (FEP), tetrafluoroethylene and hexafluoropropylene and vinylidene fluoride terpolymer (THV), silicone, or the combinations thereof.

Suitable resistivity values of the conductive composite 101 include being less than 15 ohm·cm (for example, by having carbon black) or being less than 0.05 ohm·cm (for example, by including materials disclosed herein), such as, being less than 0.01 ohm·cm, being between 0.0005 ohm·cm and 0.05 ohm·cm, or being between 0.0005 ohm·cm and 0.01 ohm·cm, depending upon the concentration of the conductive filler and the types of the resin matrices. As used herein, the term “resistivity” refers to measurable values determined upon application or post-production by using a four-point probe in-plane resistivity measurement at ambient temperature (for example, 23° C.). In one embodiment, the conductive composite 101 has at least 1% and/or at least 10% of the conductivity of the international annealed copper standard.

The conductive composite 101 has a thickness, for example, of between 0.04 mm and 2 mm, 0.04 mm and 1.6 mm, 0.05 mm, 0.5 mm, 1 mm, 1.5 mm, or any suitable combination, sub-combination, range, or sub-range therein. Other suitable thicknesses of the conductive composite 101 include, but are not limited to, between 0.04 mm and 0.1 mm, between 0.07 mm and 0.5 mm, between 0.1 mm and 0.5 mm, between 0.2 mm and 0.5 mm, greater than 0.1 mm, greater than 0.2 mm, greater than 0.4 mm, or any suitable combination, sub-combination, range, or sub-range therein.

A first illustrative embodiment involves a thermal heat rise-based conductive current sensing element. The composite material exhibits the material characteristic of heating up as electrical current is conducted.

A second illustrative embodiment involves incorporating a temperature sensitive dye into the composite formulation. This results in the visible color change of the material as heat rise occurs, correlated with increased electrical current. This “color changing current sensing element” could be implemented in interconnect housings, giving the end user immediate feedback on connector temperature without the need for an interface device.

A third illustrative embodiment utilizes the composite's tendency for thermal expansion as a pressure sensing element. During normal operation, the composite material would physically expand when heated by increasing current or ambient temperature. This thermal expansion correlated with an orders-of-magnitude increase in resistivity near the polymer melting point. When physically constrained, or under pressure, the resistance change is minimized or delayed to a higher temperature. This shift in the resistivity vs temperature curve can be correlated to indicate pressure.

A fourth illustrative embodiment utilizes the composite material's positive temperature coefficient. As the material heats up due to ambient temperature changes, the resistivity of the material increases. This relationship can be used, combined with a constant current source or constant voltage source and precision voltage measurement circuit, to measure ambient temperature in a device. This method of temperature measurement may be applied using molded conductive composites. For example, a structural plastic member within a connector housing may be made from the conductive composite, and used as a temperature sensing element which would report the actual temperature of the housing itself, without the need for additional discrete components.

A fifth illustrative embodiment utilizes the conductive composite's positive temperature coefficient. A printed circuit board assembly (PCBA) is conformal coated for sufficient electrical isolation and can be over-molded with conductive composite material. The electrical resistance of this overmolding can be measured using the technique outlined in illustrative embodiment three, and correlated with PCBA temperature rise.

A sixth illustrative embodiment involves using the physical response of the material to compression in order to make a passive materials-based “crush sensing element” with memory, which can report maximum past forces applied by developing indicative voltage when connected to an active scanner device. A crush force applied to the composite material results in a one-time, irreversible increase in composite resistivity, corresponding to the magnitude of the crush force. The crush sensing element does not require electronics during passive sensing, only upon retrieval of stored information.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A sensing element, comprising:
a conductive composite;
wherein the conductive composite has an observable property corresponding to an external condition;
wherein the sensing element is positioned for changes in the external conditions to be identifiable in a system in response to monitoring of the observable property of the conductive composite by at least a portion of the system.

2. The sensing element of claim 1, wherein the observable property is resistance.

3. The sensing element of claim 1, wherein the observable property is color.

4. The sensing element of claim 1, wherein the observable property is thermal expansion.

5. The sensing element of claim 1, wherein the observable property is measurable.

6. The sensing element of claim 1, wherein the external condition is temperature.

7. The sensing element of claim 1, wherein the external condition is pressure.

8. The sensing element of claim 1, wherein the external condition is voltage or current.

9. The sensing element of claim 1, wherein the conductive composite is physically constrained and the changes in the external condition result in the observable property being changed independent of whether the external conditions revert to original conditions.

10. The sensing element of claim 1, wherein reverting of the external conditions to original conditions results in the observable property being changed.

11. The sensing element of claim 1, wherein the conductive composite is injection molded, potted, or additively produced.

12. The sensing element of claim 1, wherein the sensing element is integrated into an electronic component selected from the group consisting of a molded interconnect device, a thermistor, an electrical connector, a circuit protection device, a housing, and combinations thereof.

13. A sensing element, comprising:
a conductive composite;
wherein the conductive composite has an observable property corresponding to external conditions;
wherein the sensing element is positioned for changes in the external conditions to be identifiable in a system in response to monitoring of the observable property of the conductive composite by at least a portion of the system;
wherein the observable property is selected from the group consisting of resistance, color, and thermal expansion;
wherein the external condition is selected from the group consisting of temperature, pressure, voltage, and current;
wherein the conductive composite is injection molded, potted, or additively produced; and
wherein the sensing element is integrated into an electronic component selected from the group consisting of a molded interconnect device, a thermistor, an electrical connector, a circuit protection device, a housing, and combinations thereof.

14. A sensing process, comprising:
providing a sensing element having a conductive composite;
monitoring an observable property of the conductive composite corresponding to an external condition;
wherein the sensing element is positioned for changes in the external condition to be identifiable in a system in response to the monitoring of the observable property of the conductive composite by at least a portion of the system.

15. The sensing process of claim 14, wherein the observable property is resistance.

16. The sensing process of claim 14, wherein the observable property is color.

17. The sensing process of claim 14, wherein the observable property is thermal expansion.

18. The sensing process of claim 14, wherein the external condition is temperature.

19. The sensing process of claim 14, wherein the external condition is pressure.

20. The sensing process of claim 14, wherein the external condition is voltage.
